(19) United States
(12) Patent Application Publication
(10) Pub. No.: US 2024/0160879 A1
(43) Pub. Date: May 16, 2024

(54) HUMAN INFORMATION MANAGEMENT SYSTEM & METHOD OF USE THEREOF

(71) Applicant: Tracy A Bishop, Montrose, CO (US)

(72) Inventor: Tracy A Bishop, Montrose, CO (US)

(21) Appl. No.: 17/986,542

(22) Filed: Nov. 14, 2022

(51) Int. Cl. G06K 19/06; G06K 19/07

(52) U.S. Cl. CPC G06K 19/06037; G06K 19/0723

(57) ABSTRACT

A human information management system & method of use thereof which generally comprises a physical main tag body, and computer related software, software programming language and code, including computer based applications, internet web page based code, and methods of applications for providing the user with a method and process to facilitate and manage the various tasks associated with accumulating, correlating, organizing, saving, storing, retrieving, and disseminating or communicating digital information across dissimilar digital computing platforms, software applications, or communications devices, that will further provide a user with current, vital, and relevant information and data pertaining to the identity, health, location, diet, feeding schedule, care to be given, prescriptions, vaccines, emergency contacts, and other generally relevant information related to a specific person, by way of QR code scan, NFC tag sensing, image recognition scan, barcode scan, or snaptag image barcode scan from a mobile or handheld device.

### CROSS REFERENCE TO RELATED APPLICATION

This application claims priority to U.S. provisional application No. 63/279,110 filed Nov. 14, 2021, the entirety of which is included herein for reference.

### FIELD OF THE INVENTION

This invention generally relates to the field of information management applications and methods of use thereof. Moreover, it pertains specifically to a new human identification and information management system & method of use that will allow users to document, store, retrieve, and communicate human related information from a multitude of sources in a seamless and continuous workflow process.

### BACKGROUND

It is well understood that people of certain demographic groups based on age, physical stature, physical health, and mental health to name a few, are limited in their ability to protect and continually care for themselves. People across multiple demographic groups require the ongoing attention, effort, and care from their families, loved ones, and care providers to ensure a stable, safe and healthy life. People across multiple demographic groups also require general medical care, physical therapy, special diet and care accommodations based on disability or age progression, as well as a safe and nurturing environment to live.

In a typical person's life there are very specific pieces of data and information related to them including their name, age, home address, allergies, medicines, vaccines, medical history, surgeries, medical contact information, family history information, emergency contacts, and more which are each known to select individuals. This typically means that while a few select individuals have access to some, or even most of the data and information, everyone else has minimal or no access to that data and information.

In a “time constraint event”, or an emergency where time is of utmost importance, it is critical to convey vital, relevant data and information to the people who need it in the emergency moment. Most people wear some type of jewelry such as a bracelet, necklace, or anklet, and some of each type of the aforementioned jewelry have been known to be used to convey medical or personal data or information such as diabetes status, heart condition, allergies, etc.

This prior art jewelry ID can contain some of the above listed information, which can be helpful in both emergency and non-emergency events such as accident, loss of memory, however that information contained on the jewelry ID very often changes over time and requires physical updating on the jewelry. This often results in the person wearing a piece of jewelry ID with outdated data and information that can have an unintended harmful or even catastrophic impact during an emergency event.

There is therefore a need for a new human data and information system, such as the one disclosed herein as the present invention, that allows a person to upload, or otherwise enter, and continually update person specific data and information, and also allow read-only access to anyone who happens to find themselves in an emergency event involving the person, in the most efficient and time sensitive manner.

### SUMMARY

The terms “invention”, “this invention”, and “the present invention” used in this patent are intended to refer broadly to all of the subject matter of this patent and the patent claims below. Statements containing these terms should be understood not to limit the subject matter described herein or to limit the meaning or scope of the patent claims below.

The term “a” or “an” entity, as used herein, refers to one or more of that entity. As such, the terms “a” (or “an”), “one or more” and “at least one” can be used interchangeably herein. The use of “including,” “comprising,” or “having,” and variations thereof, is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials, or acts, and the equivalents thereof, shall include all those described in the summary of the invention, brief description of the drawings, detailed description, abstract, and claims themselves.

Embodiments of the invention covered by this patent are defined by the claims below, not this summary. This summary is a high-level overview of the various aspects of the invention and introduces some of the concepts that are further described as the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

These and other advantages will be apparent from the disclosure of the invention(s) contained herein. The herein-described embodiments, objectives, and configurations are neither complete nor exhaustive. The Summary of the Invention is neither intended nor should it be construed as being representative of the full extent and scope of the present disclosure.

Moreover, references made herein to “the present invention” or aspects thereof should be understood to mean certain embodiments of the present disclosure and should not necessarily be construed as limiting all embodiments to a particular description.

The present disclosure is set forth in various levels of detail in the Summary of the Invention as well as in the attached drawings and Detailed Description and no limitation as to the scope of the present disclosure is intended by either the inclusion or non-inclusion of elements, components, etc. in this Summary of the Invention. Additional aspects of the present disclosure will become more readily apparent from the Detailed Description, particularly when taken together with the drawings.

The above-described benefits, embodiments, and/or characterizations are not necessarily complete or exhaustive, and in particular, as to the patentable subject matter disclosed herein. Other benefits, embodiments, and/or characterizations of the present disclosure are possible utilizing, alone or in combination, as set forth above and/or described in the accompanying figures and/or in the description herein below. Further details and other features will become apparent after review of the following Detailed Description and accompanying drawing figures.

In view of the limitations now present in the prior art, the present invention provides a new and useful human information management system & method of use thereof which is simpler in use, more universally functional, and more versatile in operation than known applications of this kind.

### DETAILED DESCRIPTION

The purpose of the present invention is to provide a new human information management system & method of use that will allow users to accumulate, correlate, and communicate information from a multitude of sources in a seamless and continuous workflow process, then convey that data and information to relevant individuals during a “time constraint”, or emergency event by use of digital scanning technology. It is also a purpose of the present invention to provide a new human information management system & method of use thereof which has many novel features not offered by prior art applications resulting in a new human information management system & method of use not anticipated either directly or indirectly by any prior art applications.

The present invention in the preferred embodiment generally comprises a physical main tag body 10, a main tag body attachment hole 15, and computer related software, software programming language and code, including computer based applications, internet web page based code, and methods of applications for providing the user with a method and process to facilitate and manage the various tasks associated with accumulating, correlating, organizing, saving, storing, retrieving, and disseminating or communicating digital information across dissimilar digital computing platforms, software applications, or communications devices, that will provide a user with current, vital, and relevant information and data pertaining to the identity, health, location, care to be given, and emergency contacts, of a specific human, as well as other information and data not referred to herein which is considered apparent and obvious to the disclosure.

The present invention, in the preferred embodiment, embodies a quick response “QR” code 20, in, and visible on, the main tag body 10. The main tag body is to be worn or removably attached to a specific person by removably connecting a wrist band, necklace, bracelet, anklet, or other similar wearable item, and alternately by inserting a ring 16 or similar fastener through the main tag body attachment hole 15. The QR code 20 embodied in the main tag body 10, wrist band, necklace, bracelet, anklet or other wearable, is read, scanned, or otherwise interacted with, thereby providing the person who is performing the QR code read, or scan, herein referred to as the “access person”, with current, vital, and relevant information and data 30 pertaining to the identity, health, location, care to be given, and or emergency contacts, of a specific human, as well as other information obvious to the disclosure.

It is anticipated that the data and information 30 conveyed from the main body tag of the specific human, to the access person by means of the QR code scan, can be instantly presented to them in a variety of ways including as a readable PDF, as a webpage, as digital audio, as a text or SMS message, or other manner not referred to herein that performs the same purpose and function for providing a useful and helpful method of ensuring that proper care is given to the specific human, or person, in the form of medication and or medical treatment or procedures.

It is intended that the present invention disclosed herein, in the preferred embodiment, allow a primary user, or primary user representative, to upload or enter person specific data and information, into a main services webpage, website, application (APP) page, database, data form or server, with the use of virtually any software application interface, including but not limited in use to, internet application or APP based text entry fields, internet based webforms, Microsoft Word, Pages, Notepad, WordPad, Notes, Google DOCS, Adobe, PDF Reader, and other similar software applications that accomplish the same purpose and function, in a manner that will allow a primary user to selectively accumulate, enter, store, filter, access, edit and otherwise manage information related to a specific person for the purpose of generating a personal identification tag to be worn or otherwise affixed to a specific person, thereby allowing the primary user, or an undetermined secondary user to quickly access person specific data and information from a remote location removed from the actual main services website, data server, database, or other digital file, data or information repository not referred to herein that performs the same purpose and function and is to be considered apparent and obvious to the disclosure contained herein, whereby the person specific data and information will provide said users with relevant, vital, actionable information pertaining to the identity, health, location, care to be given, and emergency contacts of the specific person.

It is further intended that the method of remotely scanning a QR code 20 embodied in the main tag body 10, to access the human related data and information 30, can also be accomplished with similar technologies that accomplish the same purpose and function and are therefore to be considered apparent and obvious to the disclosure contained herein. These anticipated technologies include but are not limited to, Near-Field Communication (NFC) tags, Image Recognition, Barcode, and SnapTag Barcode Imagery. Near-Field Communication (NFC) tags utilize technology available on most smart phones devices and rely on proximity sensing between the device and the tag to trigger or initiate the programmed action such as initiating the opening of a webpage, APP, stored document, or similar interface that provides the user with the relevant data and information. Image Recognition scanning technology may also be used from a smartphone or other handheld device to scan the tag, which in this instance may comprise a customer or person specific image 40, which when scanned will trigger or initiate the programmed action such as initiating the opening of a webpage, APP, stored document, or similar interface that provides the user with the relevant data and information. Barcode scanning technology may also be embodied in the present invention to trigger or initiate the programmed action such as initiating the opening of a webpage, APP, stored document, or similar interface that provides the user with the relevant data and information upon scanning. SnapTag Barcode Imagery can further be used to turn any customer or person specific image into a barcode that when scanned will trigger or initiate the programmed action such as initiating the opening of a webpage, APP, stored document, or similar interface that provides the user with the relevant data and information.

It is to be understood that the main tag body 10 and related QR code 20, NFC tag, Image recognition scan, barcode scan, snaptag scan, or similar specific data and information identifying and conveyance method or technology, can be embodied as an epoxy resin ID 50, key chain ID, stamped metal ID, pendant ID, bag tag ID, purse ID, back pack ID, phone cover ID, car visor clip ID, rear view mirror ornamental ID. Bike ornamental ID, wallet card ID, neckwear jewelry ID, neckwear wrap ID, wrist wrap ID, ankle wrap ID, faux jewelry ID, costume jewelry ID, surfer zipper clip ID, zipper clip ID, snow sport clip ID, water sport clip ID, life vest clip ID, extreme sport clip ID, graphic ID for clothing, sewn patch ID, iron branding tool ID for embossing, faux tattoo ID, embossed ID, etched ID, engraved ID, printed ID, electronic ID, or digital ID.

It is to be understood that the QR Scan, NFC tag, image recognition scan, barcode scan, snaptag scan code may be accompanied by visuals such as graphics 45, icons, images, or other type of visual indicators or references including those specific to medical conditions, diseases, diet, care needs as well as others not referred to which are to be considered apparent and obvious to the disclosure. Additionally, text may further accompany the QR code, NFC tag, image recognition scan, barcode scan, snaptag scan, code in the form of words, statements, names, calls to action such as “Help Me Phone Home”, I Have Trouble Remembering Things”, “I suffer From Seizures” or other text-based messages not referred to herein yet obvious to the disclosure.

It is also intended that the main tag body 10, in the preferred embodiment of the present invention, be manufactured using plastic materials including, resins, acrylics, polymers, plastic composites, and other materials not referred to herein which perform the same function and are to be considered apparent and obvious to the disclosure contained herein. Additional embodiments of the tags may be manufactured using a variety of metal materials including but not limited to steel, stainless steel, aluminum, copper, silver, gold, zinc, platinum, and other metals and composites thereof not referred to herein that perform the same purpose and function as the invention disclosed herein. The main tag body of the preferred embodiment is further intended to comprise a hole for inserting a ring, chain, wire, string, clip, band, strap or other similar fastener intended to attach the tag to the wrist, neck, ankle, arm, or article of clothing or clothing accessory of a specific person. An alternate embodiment of the invention allows the tag to be attached or affixed to a strap slide fastener 17 having first and second openings 18 at opposing end to allow the tag 10 and strap slide fastener 17 to be removably attached to the wrist, neck, ankle, arm, or article of clothing or clothing accessory of a specific person.

It is to be understood that the main service website of the preferred embodiment will be developed in a manner that will allow a user to access and interface with the main service website and all associated aspects, features, and or functions of the website, from either a wired or wireless connection from a variety of electronic desktop or handheld communications devices including but not limited in use to, desktop PC, Laptop computer, handheld electronic device such as Palm Pilot, Blackberry, IPhone, IPad, cell phone, Smart PDA, smart watch, QR scanner, and other similar devices not referred to herein which can be used to access the internet and thereby access the main service website disclosed herein.

It is to be further understood that the present invention in the preferred embodiment disclosed herein can be marketed to a user in a variety of commercial options, referred to herein as “Personal Information ID” options including but not limited to “Basic Tag”, “Information Tag”, and “Dynamic Tag”, whereby each different commercial embodiment will offer varying levels of service to the user.

The varying levels of commercial options will further be differentiated based on the range of services user's desire of what type of interactive care service they wish to be given to a specific person in their absence or if the user is otherwise unable to audibly or physically dictate care to be given to a specific person at the time of an emergency event. Limitations related to quantity, length, and editability of data and information points may be imposed based on the Human Information ID option choice.

A first embodiment of an Human Information ID option is the “Point of Sale (POS) or Simple Basic Tag” option of the preferred embodiment, which allows a user to purchase a tag, either from a physical brick and mortar retail location or an online retail location, then activate the tag, either through an online website, mobile application (APP), email, SMS, or phone in process, therein selectively accumulate, enter, store, filter, access, edit and otherwise manage the “Name” of the human, the “Contact” information pertaining to the human, and then have the QR scan code generated to be printed and inserted into a receiving slot 51 or cavity of the tag body enclosed by a removable end cap 55. In this embodiment of the invention disclosed herein, the QR scan code is not created or generated until the user has entered all relevant human specific related information. Once entered, the website, APP, or other user interface can allow for the QR scan code to be saved, downloaded, and or printed for the purposes of inserting into the main tag body. This POS embodiment allows for the QR scan code to be removably inserted into the main tag body by way of inserting it into a closable or sealable slot 51, cavity, compartment, or other type of void in the main tag body that can receive the QR scan code and then be sealed closed with a removable end cap 55. This embodiment may further provide the user with the option to upload, save, and print a photo of the human for the purposes of being inserted into the main tag body in a manner similar to the printed QR scan code disclosed herein.

Other embodiments of the invention comprise the QR scan code as an embedded feature of the tag whereby the QR scan code is printed, etched, stamped, or otherwise permanently embedded and embodied into the main tag body prior to the POS. This POS embodiment allows for the QR scan code to be associated with a specific “Profile Template” that pre-exists on a computer server or database, and can be accessed by the user by utilizing a computing device such as a desktop, laptop, or mobile computing device to access a website wherein a user would be able to enter, edit, update or otherwise manage, data and information pertaining to one or more specific persons, as well as a person or persons associated with said specific person(s). In this POS embodiment, the pre-generated QR scan code can be associated or connected to the “Profile Template” either before the POS during the manufacturing process, or after the POS whereby the user would initiate the association or connection via the “Profile Template” website. This embodiment may further provide the user with the option to upload, save, and print a photo of the specific person for the purposes of being inserted into the main tag body in a manner similar to other embodiments disclosed herein.

Point of Sale (POS) or Simple Basic Tag

QR Type: Static (non editable)
Cost:
Basic Tag Information
Person's name
Photo:
Emergency Contact Name:
Phone #
Contact Name:
Phone #
QR CODE:

A second embodiment of an Human Information ID option is the “Basic Tag” option of the preferred embodiment, which allows a user to selectively accumulate, enter, store, filter, access, edit and otherwise manage the “Name” of the specific human, the “Contact” information pertaining to the specific human, and the generated QR scan code.

Basic Tag

QR Type: Static (non editable/or editable)
Cost:
Basic Tag Information
Person's name
Photo:
Emergency Contact Name:
Phone #
Contact Name:
Phone #
QR CODE:

A third embodiment of an Human Information ID option is the “Information Tag” option of the preferred embodiment, which allows a user to selectively accumulate, enter, store, filter, access, edit and otherwise manage the Name” of the specific human, the “Contact” information pertaining to the specific human, the “Photograph” or likeness image of the specific human, and the generated QR scan code. It is to be understood that the “Photograph” or “Photo” or likeness image of the specific human, can be represented, accumulated, entered, stored, filtered, accessed, edited and otherwise managed in digital or physical form, whereby the digital form can be uploaded, changed, deleted, archived, and printed from a computer related software, software programming language and code, including computer based applications, internet web page based code, and methods of applications used in the creation of the preferred embodiment of the present invention. The “Photograph” or “Photo” or likeness image of the specific human, can also be printed into physical form on print media and applied, inserted, adhered or otherwise removably or fixedly attached to the main tag body, thereby allowing for visual confirmation that the tag and related data and information belongs to the related specific human.

Information Tag

| | |
|---|---|
| QR Type: | Static (non editable) |

Cost:
Basic Tag Information
Person's name
Photo:

| | |
|---|---|
| Emergency Contact Name: | Phone # |
| Contact Name: | Phone # |

QR CODE:

| | |
|---|---|
| Adress: | City, State: Zipcode: |

Phone #
Disabilities Awareness: (deaf, blind, autistic, PTSD, etc.)
Current Medications:
Allergies: (food, liquid, medicine, etc.)
Implant Awareness: (hearing aids, pace maker, metal plates, metal pins,
etc.)
Insurance: (Insurance Type:, Name:, Company:, Policy#:, Group #:,
DOB:, Insurance Phone Number:, etc.)
QR CODE:

A fourth embodiment of a Human Information ID option is the “Medical Tag” option of the preferred embodiment, also referred to herein as the “Hospital Tag”, “Vaccine Status Tag”, or the “Insurance Tag”, which allows a user to selectively accumulate, enter, store, filter, access, edit and otherwise manage the “Name” of the human, the “Contact” information of the human, the “Photograph” or likeness image of the human, the Doctor or “Medical Contact” information, the “Medical History” information pertaining to the human, the “Insurance” information pertaining to the human, the “Vaccine” or shot information pertaining to the human, and the generated QR scan code.

Medical Tag

QR Type: Dynamic (Text only: editable)
Basic Tag Information
Contact name
Photo:
Phone #
Blood Type:
Contact Name:
Phone #
Disabilities Awareness: (deaf, blind, autistic, PTSD, etc.)
Current Medications:
Allergies: (food, liquid, medicine, etc.)
Implant Awareness: (hearing aids, pace maker, metal plates, metal pins,
etc.)
Insurance: (Insurance Type:, Name:, Company:, Policy#:, Group #:,
DOB:, Insurance Phone Number:, etc.)
Vaccine Status:
Medical Facility: (Name:, Location:, Phone Number:, Contact Person:,
etc.)
QR CODE:

It is to be understood that additional embodiments of an Human Information ID option of the preferred embodiment can be created by offering various pieces of data and information based on “service level”, “payment tier”, subscription option”, “a-la-carte” choice selection, or a wide variety of other data point or service option combinations that are considered anticipated marketing options of the present invention and are therefore to be considered apparent and obvious to the disclosure contained herein.

Employee Tag

QR Type: Dynamic (Text only: editable)
Basic Tag Information
Contact name
Photo:
Contact Name:
Phone #
Company Contact Name:
Phone #
Disabilities Awareness: (deaf, blind, autistic, PTSD, etc.)
Current Medications:
Allergies: (food, liquid, medicine, etc.)
Implant Awareness: (hearing aids, pace maker, metal plates, metal pins,
etc.)
Workers Comp: (Insurance Type:, Name:, Company:, Policy#:, Group #:,
DOB:, Insurance Phone Number:, etc.)
Vaccine Status:
Company Information: (Name:, Location:, Phone:, Contact Person:, etc.)
QR CODE:

An alternate embodiment of the invention is the Employee Tag Human information tag: this embodiment comprises the person's vital information of the preferred embodiment and Medical Tag, plus the person's company name, contact information for the company, and the company's workers comp information (instead of the individual personal insurance information)

Wildlife License Tag

QR Type: Dynamic (Text only: editable)
Basic Tag Information
Contact name
Photo:
Contact Name:
Phone #
Drivers/Personal License or ID#:
Phone #
Disabilities Awareness: (deaf, blind, autistic, PTSD, etc.)
Current Medications:
Allergies: (food, liquid, medicine, etc.)
Implant Awareness: (hearing aids, pace maker, metal plates, metal pins,
etc.)
Wildlife Licenses: (Hunting:, Fishing, Small Game:, Big Game: Camping:
Parks:)
Vaccine Status:
QR CODE:

An alternate embodiment of the invention is the Human-Wildlife license information tag: This information user profile will hold a copy of a user's state driver/personal license and electronic documents of current active wildlife license(s), such as fishing and hunting licenses, park access licenses, camping licenses, state wildlife rea fee info. It enables the individual to clip their tag on their person while in the woods/terrain without having to take additional materials such as a wallet or purse.

The present invention, in additional applications of the preferred embodiment, is intended to be used as a “Travel Accommodation Tag”, whereby the user selects a “Travel” option, or otherwise indicates within a person's data and information profile, and or travel intentions. This option or feature will collect travel related information from the user, including but not limited to, dates of travel, origin of travel, destination of travel, duration of travel, transportation method of travel, transportation information of travel, travel itinerary, reservation numbers, hotel/lodging name with phone number and other information related to travel not referred to herein which is to be considered apparent and obvious to the disclosure. The method of attachment to travel related accessories is anticipated to be straps, ties, clips, rings, adhesive, as well as other fasteners that perform the same purpose and function and are to be considered apparent and obvious t the disclosure contained herein.

The present invention, in additional applications of the preferred embodiment, is intended to be used as a “Hotel/Public Lodging Tag”, whereby the user selects a “Hotel” or “Public Lodging” option, or otherwise indicates within a person's data and information profile, hotel or public lodging intentions. This option or feature will collect hotel of public lodging related information from the user including but not limited to travel itinerary, lodging information such as dates, locations, reservation numbers, boarding information, and other information related to hotel or public lodging not referred to herein which is to be considered apparent and obvious to the disclosure.

The present invention, in another additional application of the preferred embodiment, is intended to be used and provided by the Hotel/Public Lodging entity as a “Guest Tag”, whereby the Hotel/Public Lodging entity provides, to their guests who are staying with them, a “Room ID Tag” to place on their person during their stay. This Room ID Tag provides an additional service from the lodging entity providing additional comfort and a form of security for their guest's during their stay. In the event that a guest gets lost, injured, or is otherwise in a position that is remote or removed from the family, contact person, or guest of the Hotel/Public Lodging entity, and is further in need of immediate emergency care, the Room ID Tag will provide responders with all relevant emergency related information, including but not limited to, contact phone numbers, SMS numbers, email addresses, treatment plan, medical records, prescription information, doctor phone numbers, as well as other information and data. The Room ID Tag may further allow a guest of the Hotel/Public Lodging entity, or authorized person removed from the Hotel/Public Lodging entity, such as a service provider in a different state, to be able to track or otherwise locate the person by utilizing Global Positioning System (GPS) tracking technology embedded or affixed to the person in the form of a chip, or embedded or removably attached to the Room ID Tag, thereby allowing for the person to be tracked and located through a website, mobile APP, or other GPS locator device or service not referred to herein that performs the same purpose and function and is to be considered apparent and obvious to the disclosure contained herein.

An alternate embodiment of the present invention comprises a QR code, NFC tag, Image recognition, barcode, or snaptag, component of the main tag body and a separate photo component that can be removably or fixedly connected together. This allows for the user to update, upgrade, modify, change, replace, or otherwise manage either of the components independently without requiring the replacement of the other. This embodiment will also allow for the commercial marketing and sale of either component individually, such as at point of purchase brick and mortar or online retail sales locations.

Another alternate embodiment of the present invention allows the QR code, NFC tag, Image recognition scan, barcode scan, snaptag scan, or similar specific data and information identifying and conveyance method, component of the invention to be commercially marketed and offered for sale at point of purchase brick and mortar or online retail sales locations, whereby the QR code, NFC tag, Image recognition scan, barcode scan, snaptag scan, or similar specific data and information identifying and conveyance method is used in combination with a second secure identifier, such as a username, password, security key, security code, or similar security method, to access a user specific, secure main services webpage, website, application (APP) page, database, data form or server, thereby allowing them to upload or enter person specific related data and information, save the data and information, then access the same saved data and information at a future time by using the QR code, or similar specific data and information identifying and conveyance method, and related second secure identifier, such as a username, password, security key, security code, or similar security method not referred to herein which is to be considered apparent and obvious to the disclosure contained herein. Further, the QR code, or similar specific data and information identifying, and conveyance method is intended to be embodied in a main tag body and removably attached to the specific human.

The present invention in the preferred, and alternate embodiments, will allow medical personnel to manage, track, and care for patients. This application of the invention includes the ability to manage, facilitate, organize, schedule, share, and update, feedings, medicines, vaccinations, general health care, environment cleanings, relocations, and handling and engagement safety measures and protocols as well as other tasks, data, and information related to medical facility-based patients.

The present invention in the preferred, and alternate embodiments, will further allow for real-time data and information related to humans to be collected, stored, evaluated and analyzed for insurance related purposes. This application of the invention includes the ability to collect and share data and information related to the insurance coverage, payments, costs, medical management, location, transportation, scheduling, feeding, medical, vaccination, general health care, movement, as well as handling and engagement safety measures and protocols associated with a specific person, as well as other tasks, data, and information related to people individually or in a group setting.

It is to be further understood that the present invention in the preferred, and alternate embodiments, will further allow for real-time data and information collection access, editing, and dissemination, related to incarcerated or imprisoned people to be collected, stored, evaluated and analyzed. This application of the invention includes the ability to collect and share data and information related to the identification, management, location, transportation, scheduling, feeding, medical, vaccination, general health, general health care requirements, movement, and handling and engagement safety measures and protocols as well as other tasks, data, and information related to processing and management of detained, incarcerated or imprisoned people.

An alternate embodiment of the various embodiments of the invention, may comprise a Global Positioning System (GPS) tracker embedded within, or removably attached to, the main tag body of the invention. GPS tracking capabilities allow the real time location of a person to be accessed and monitored through the main service website disclosed in the preferred embodiment of the invention. This embodiment of the invention combines the ability to deliver data and information relevant to the person to a user or access person who scans the tag, with the ability for the access person or other relevant party to remotely locate the person using the geolocation capabilities of the GPS tracking system. This embodiment of the invention may further be utilized to geo-positionally identify a specific person associated with the main tag body of the invention disclosed herein. In the wildlife tag embodiment of the invention, GPS capabilities will allow a scanning party to verify identity and location of the specific person being scanned and verified.

An alternate embodiment of a Human Information ID option of the preferred embodiment is intended to include data and information pertaining to Emergency Planning, including but not limited to instructions and planning steps describing what to do in the event of an emergency such as a fire, earthquake, flood, tornado, hurricane, lockdown, marshal law, riot, break-in, as well as other emergencies not disclosed herein which are to be considered apparent and obvious to the disclosure contained herein. The emergency planning related information is intended to be used for Family emergency planning, Corporate or Company emergency planning, Educational System emergency planning, whereby the data and information is input by a user in the same manner and method as outlined in the preferred embodiment of the invention and can be accessed, edited, updated, and disseminated in the same manner and method disclosed in the preferred embodiment of the invention disclosed herein.

Overview of the present invention process disclosed herein:

### Step 1

### Overview Options of Human Id Tag

### 1: Emergency Care Assistance ID(Formerly Called First Responder Codes)

The customer's Emergency Care Assistant ID will hold customer pertinent information to assist during an emergency. First Responders will be able to scan and immediately view the customer's medical care needs, such as medication allergies, medical implants, disabilities, and more! The customer's ID will assist First Responders if the customer is not able to at that moment and give peace of mind to the customer's loved ones.

### 2: Family Emergency Plan

The Family Emergency Plan provides step-by-step guides to the customer and their family by scanning the code during an event. The customer and their family design these plans to help ensure that pertinent information and key details of “who does what” and “where to meet” are readily available for everyone. The company will provide the customer with the templates, the customer will fill in accordingly, and the company will create the customer's key codes.

***option to purchase additional keys for each family member

### Step 2:

Direct consumer to shop page on the company's website to select ID option and quantity for purchase. Advise consumer that Id systems require an annual subscription to keep code active. Initial order includes Base Annual Plan.
Two annual subscription plans available:
Base Plan $11.99 (Sample Cost)
(Allows 3 updates per year at no additional charge)
10 Plan $20.99 (Sample Cost)
(Allows 10 updates per year at no additional charge)
   **Please note Annual Subscriptions keep customer coding activated. Codes will expire after 12 months without renewal, meaning code is deactivated and no longer readable.

### Step 3:

Once payment is received by the company, the company will email consumer the template/link to complete data for QR coding. Once complete they will submit their form to the company for order processing.

Yet another alternate embodiment of the invention comprises a Radio Frequency Identification (RFID) tag or microchip embedded, inserted, or otherwise attached to the main tag body for the purposes of conveying or transmitting data and information relevant to the person to a user. This application eliminates the need to invasively insert the RFID tag or microchip into the person's body. This further allows for the tag or microchip to be changed or removed without invasive surgery. It is to be understood that the RFID device, combined with the human information management system disclosed herein can be either passive or active to meet the desired scanning and transmitting options anticipated in the present invention. The RFID device is intended to have a transmitter and power source (typically a battery). The power source is intended to run the microchip's circuitry and to broadcast a signal to a reader such as a handheld or mobile communications device. The passive RFID tag is intended to draw power from the reader, which sends out electromagnetic waves that induce a current in the tag's antenna, thereby eliminating the need for a battery power source. Semi-passive tags may also be utilized in the invention disclosed herein, and are intended to use a battery to run the chip's circuitry, and initiate communication and thereby data and information transference by drawing power from the reader device.

The foregoing has outlined, in general, the complete detailed description of the process, and or methods of application of the invention and is to serve as an aid to better understanding the intended application and use of the invention disclosed herein. In reference to such, there is to be a clear understanding the present invention is not limited to the method or detail of process, fabrication, end use, or application of use described and illustrated herein. Any other variation of process, use, or application should be considered apparent as an alternative embodiment of the present invention.

### BRIEF DESCRIPTION OF THE DRAWINGS

The following drawings further describe by illustration the advantages and objects of the present invention.

FIG. 1. Shows a line drawing of the front side of the present invention comprising text and graphic embedded in an acrylic tag body, further comprising a hole for receiving an attachment ring.

FIG. 2. Shows a line drawing of the back side of the present invention comprising a QR code embedded in an acrylic tag body, further comprising a hole for receiving an attachment ring.

FIG. 3. Shows a line drawing of the front side of the present invention in an alternate shape, comprising text and graphic embedded in an acrylic tag body, further comprising a hole for receiving an attachment ring.

FIG. 4. Shows another line drawing of the back side of the present invention in an alternate shape, comprising a QR code embedded in an acrylic tag body, further comprising a hole for receiving an attachment ring.

FIG. 5. Shows a line drawing of the end view of the present invention comprising text and QR code embedded in an acrylic tag body, further comprising a hole for receiving an attachment ring.

FIG. 6. Shows a line drawing of the side view of the present invention comprising text and QR code embedded in an acrylic tag body, further comprising a hole for receiving an attachment ring.

FIG. 7. Shows a photo of the front sides of two different embodiments of the present invention having different shapes, comprising text and graphic embedded in an acrylic tag body, further comprising a hole for receiving an attachment ring.

FIG. 8. Shows a photo of the back sides of two different embodiments of the present invention having different shapes, each comprising a QR code embedded in an acrylic tag body, further comprising a hole for receiving an attachment ring.

FIG. 9. Shows a photo of the back sides of two different embodiments of the present invention having different shapes, each comprising a QR code embedded in an acrylic tag body, further comprising a collar attachment ring attached.

FIG. 10. Photo of three embodiments showing the front side of the present invention comprising a graphic, text, and QR code embedded in an acrylic tag body, further comprising a hole one with an attachment ring, and one with a carabiner attached.

FIG. 11. Photo of the front side of the present invention comprising text and graphic embedded in an acrylic tag body, further comprising a hole for receiving an attachment ring.

FIG. 12. Photo of the front side of another embodiment of the present invention comprising text and graphic embedded in an acrylic tag body, further comprising a hole for receiving an attachment ring.

FIG. 13. Photo of the front side of yet another embodiment of the present invention comprising text and graphic embedded in an acrylic tag body, further comprising a hole for receiving an attachment ring.

FIG. 14. Shows a line drawing of the front side of the present invention with a metal tag body inserted on a strap slide fastener comprising attachment holes installed on a clothing accessory strap.

FIG. 15. Shows a line drawing of the front side of the present invention comprising text and graphic inserted in an acrylic tag body with a slot cavity and a removable end cap, further comprising a hole for receiving an attachment ring.

FIG. 16. Shows a line drawing of the back side of the present invention comprising a QR code inserted in an acrylic tag body with a slot cavity and a removable end cap, further comprising a hole for receiving an attachment ring.

FIG. 17. Shows a line drawing of the front side of the present invention in an alternate shape, comprising text and graphic inserted in an acrylic tag body with a slot cavity and a removable end cap, further comprising a hole for receiving an attachment ring.

FIG. 18. Shows another line drawing of the back side of the present invention in an alternate shape, comprising a QR code inserted in an acrylic tag body with a slot cavity and a removable end cap, further comprising a hole for receiving an attachment ring.

FIG. 19. Shows a line drawing of the end view of the present invention comprising text and QR code inserted in an acrylic tag body with a slot cavity and a removable end cap, further comprising a hole for receiving an attachment ring.

FIG. 20. Shows a line drawing of the side view of the present invention comprising text and QR code inserted in an acrylic tag body with a slot cavity and a removable end cap, further comprising a hole for receiving an attachment ring.

FIG. 21. Shows a diagram of a process flow for one embodiment of the present invention illustrating the steps from initial user to end user.

FIG. 22. Shows a listing of data and information inputs for a Medical Tag for a specific person and contact user profile for one embodiment of the present invention illustrating the information to be entered by a user.

FIG. 23. Shows a diagram of a process flow for one embodiment of the present invention illustrating the steps from a specific person, contact user, specific person and contact user profiles, computer server database, second user with QR code reader, and specific person with QR code tag.

FIG. 24. Shows a data sheet containing user and specific user profile information related to a Fire Emergency Plan embodiment of the present invention.

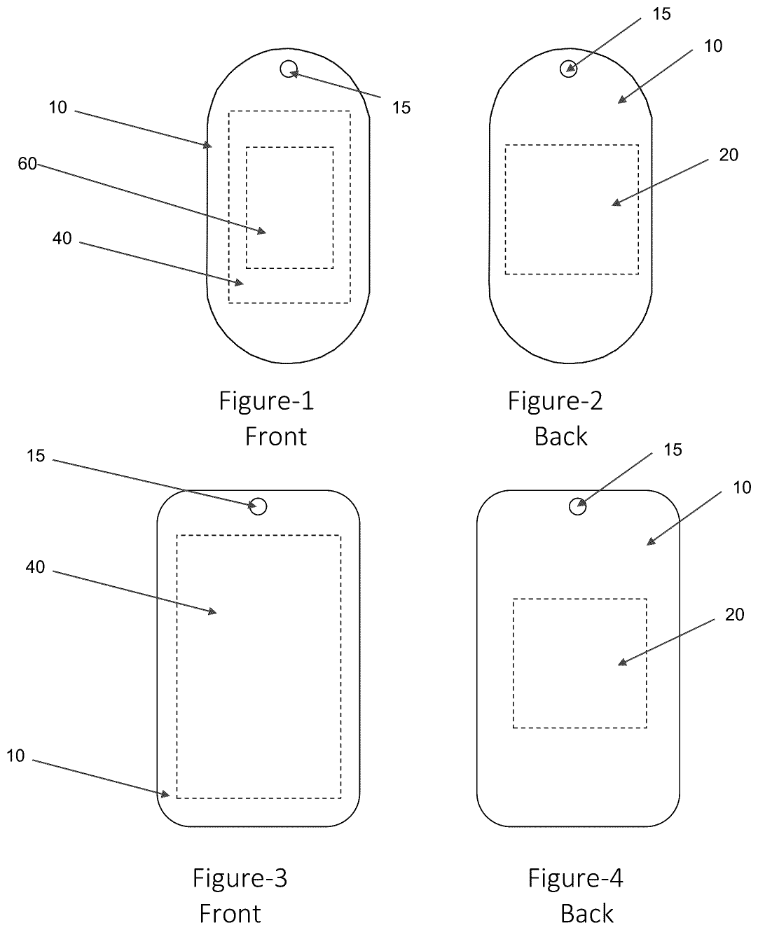

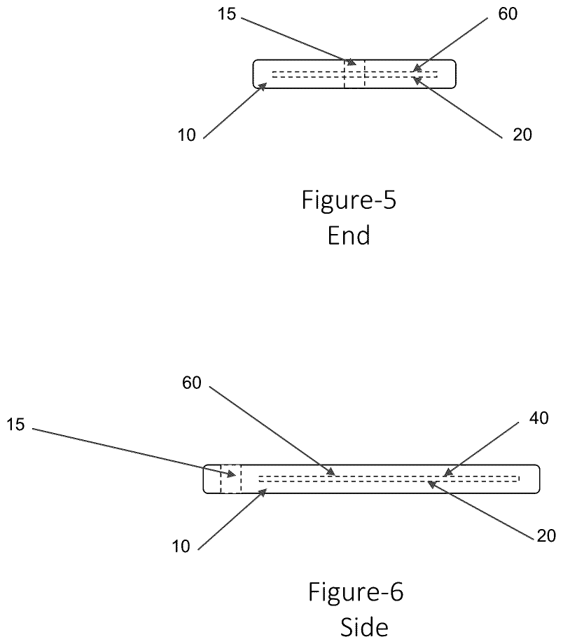

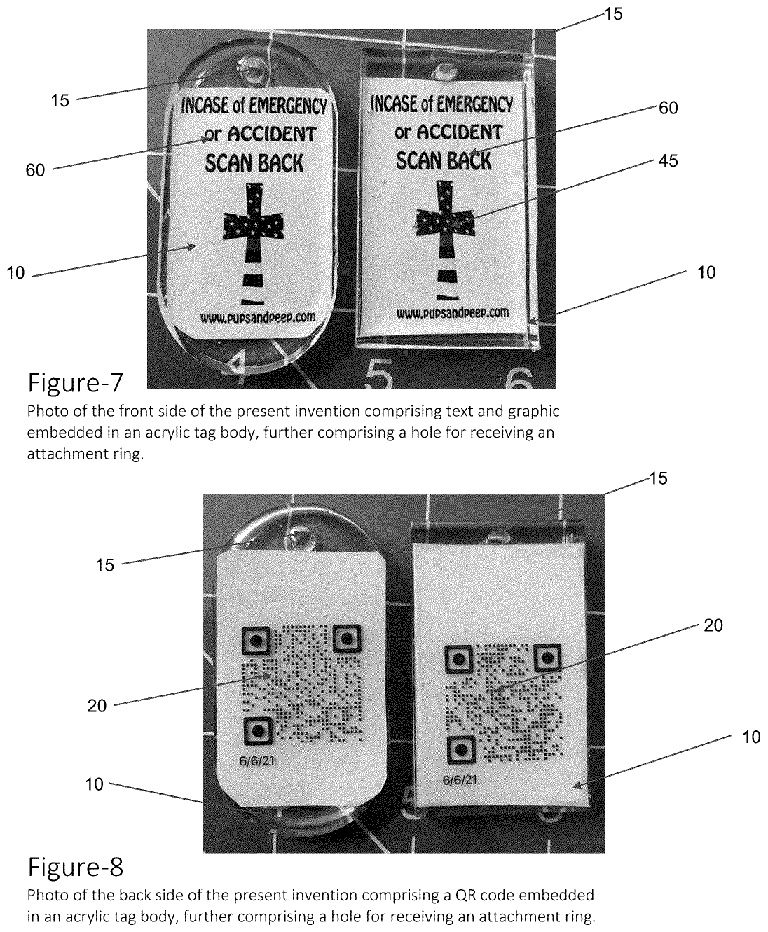

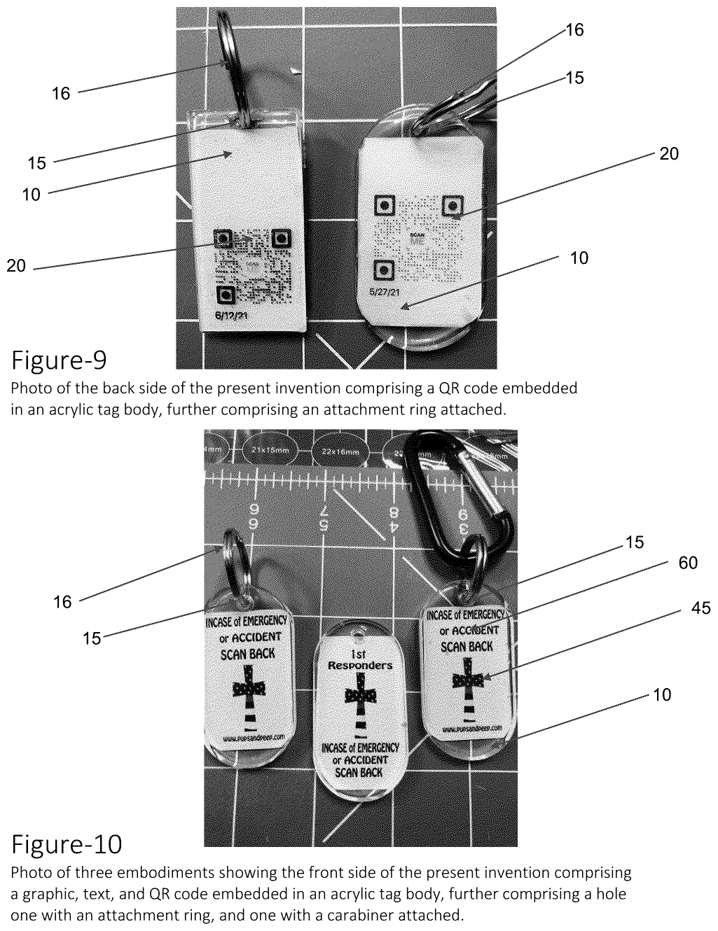

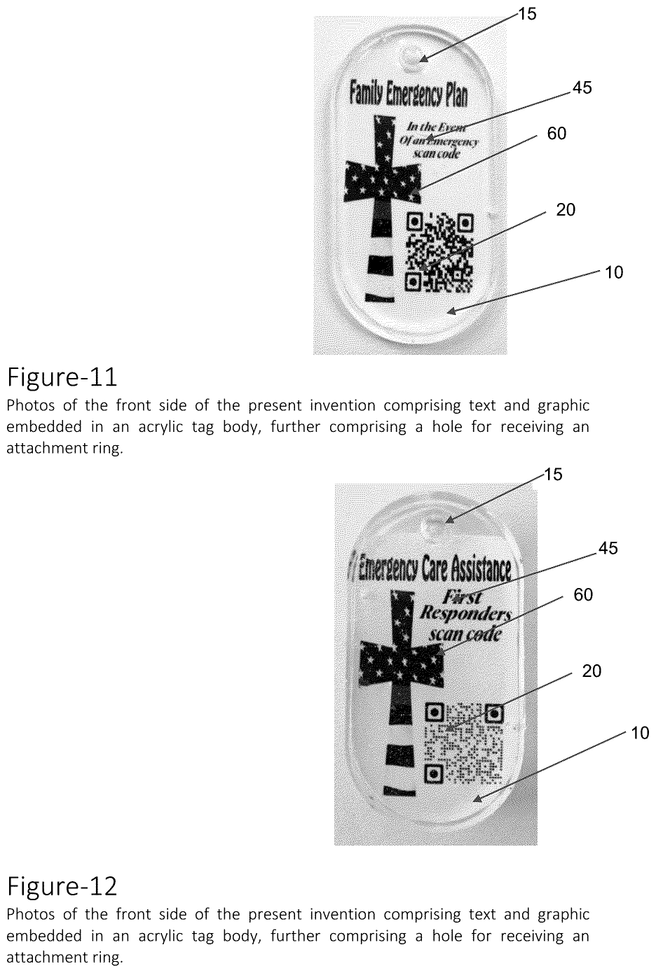

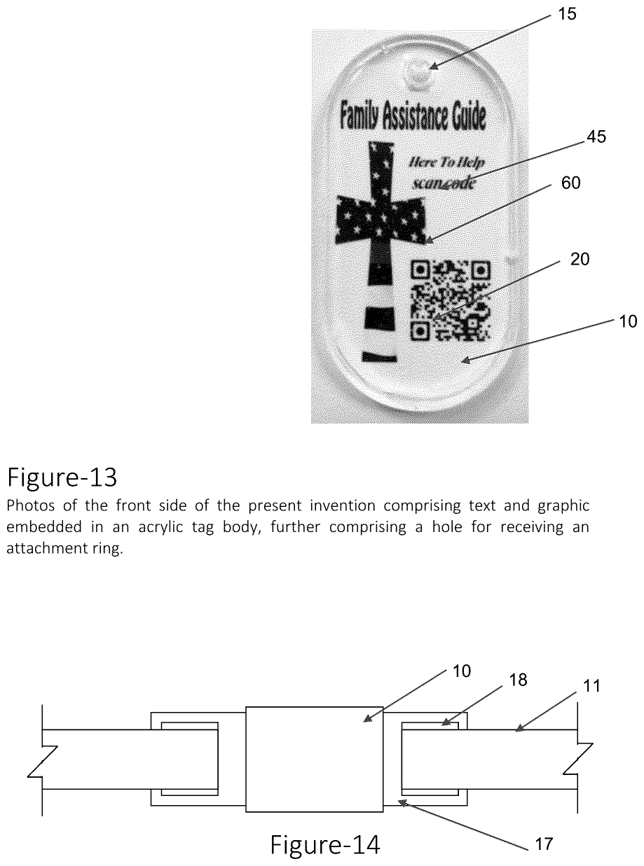

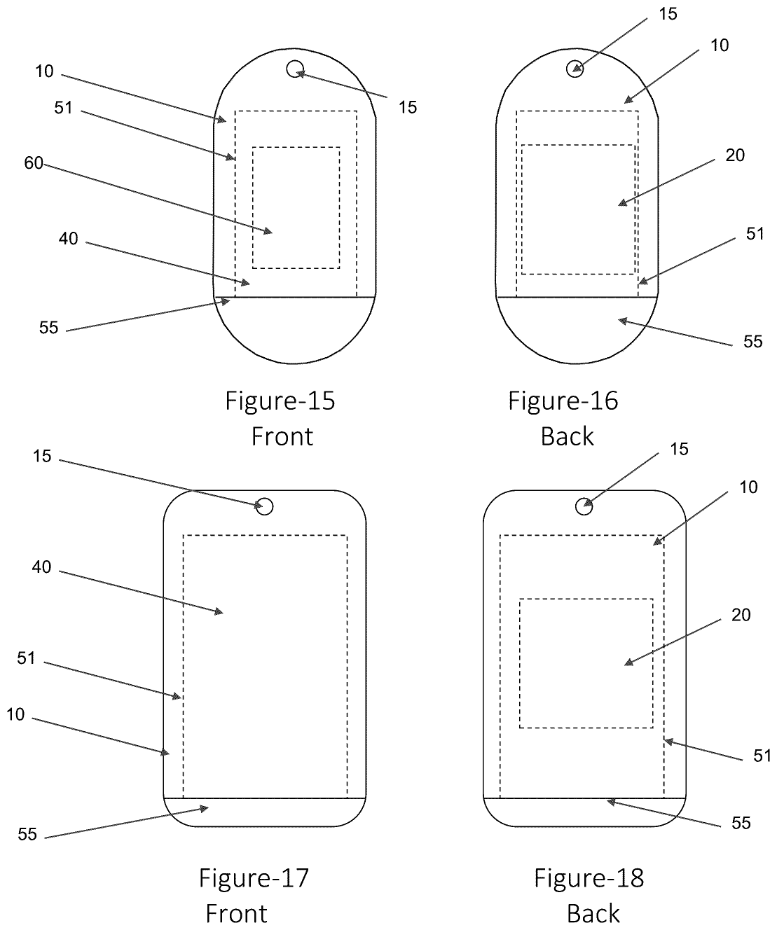

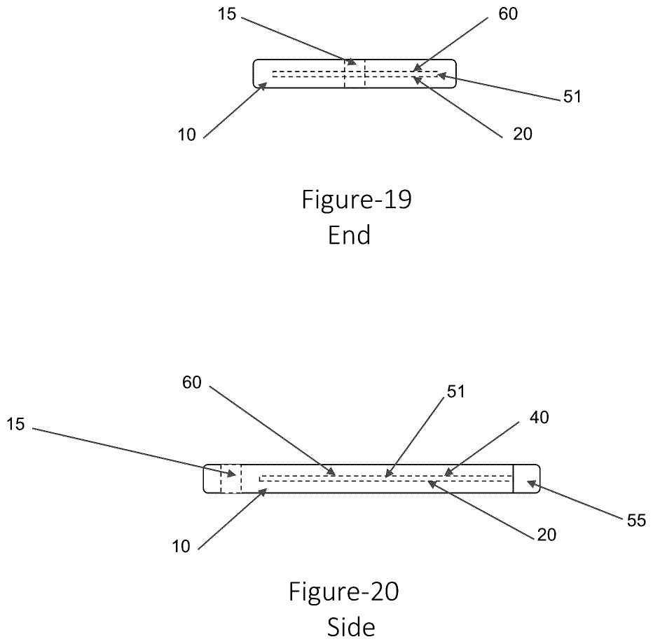

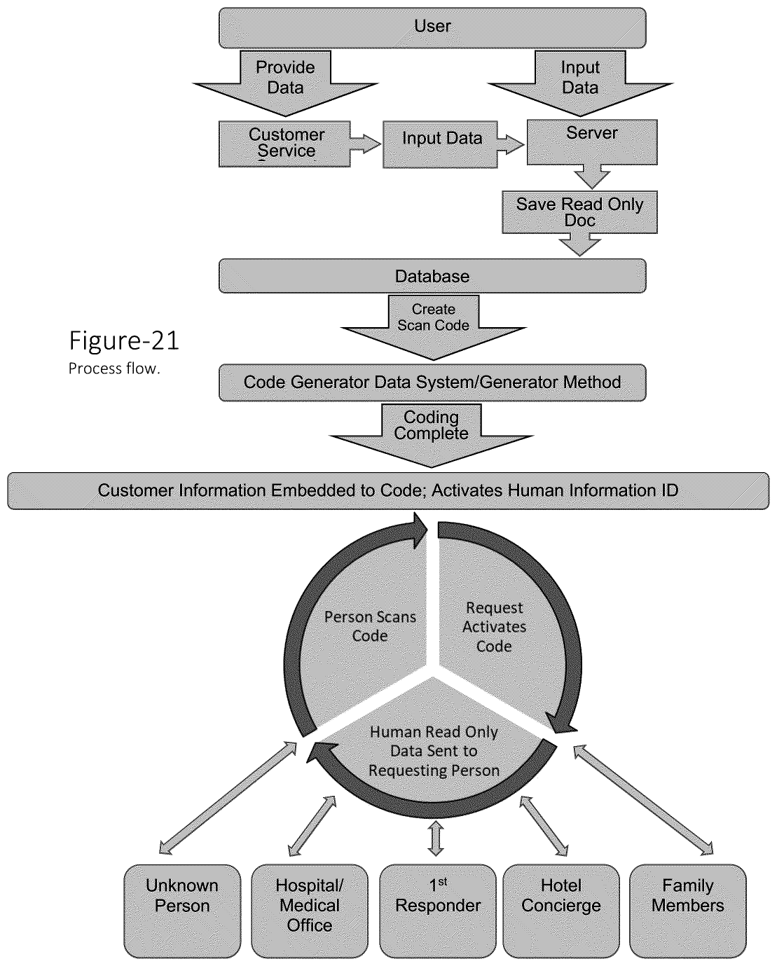

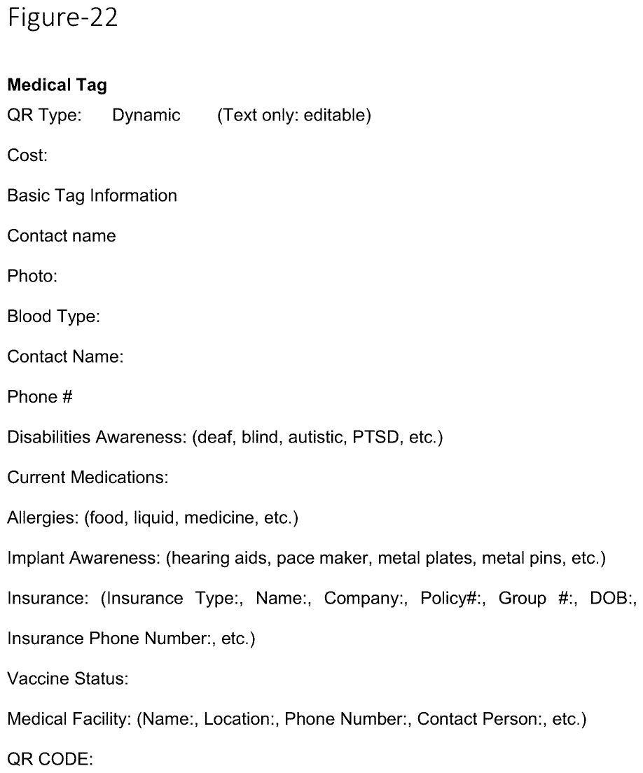

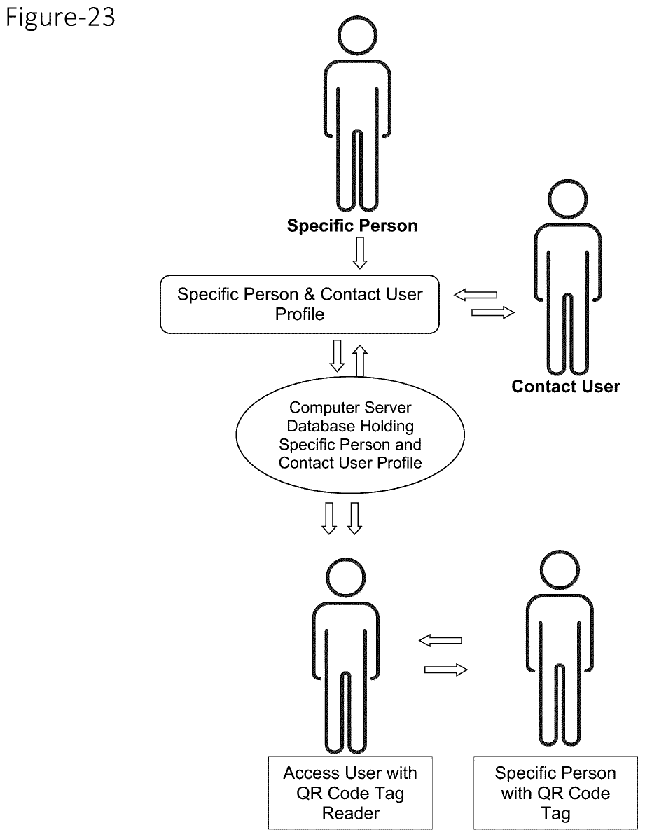

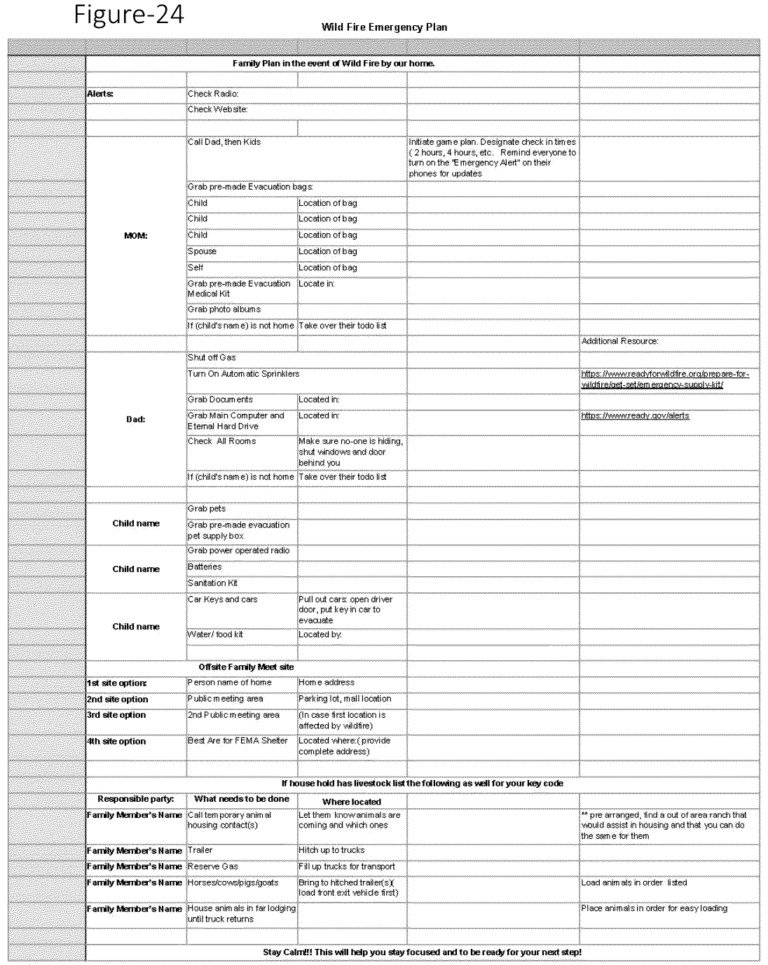

1. A method for conveying human specific emergency information from a tag associated with a first user to a second user, comprising: a user specific emergency information profile tag, storing a computer server based user specific emergency information profile, and a tag recognition device; for providing a first user with a process for remotely entering, saving, and updating, user specific emergency information across computing devices; providing a second user with access to retrieve current emergency information pertaining to the identity, health, medical diagnosis, prescriptions, emergency contacts, medical devices, residence location, diet, feeding schedule, and care to be given related to a first user, by way of data transfer from the emergency profile tag to a computing device.

2. The method for conveying human specific emergency information from a tag associated with a first user to a second user of claim 1, wherein the tag embodies a quick response (QR) code.

3. The method for conveying human specific emergency information from a first user to a second user of claim 2, wherein the quick response (QR) code, NFC tag, Image, barcode, or snaptag is pre-generated and pre-associated with a generic “Profile Identifier” prior to any user information being entered into the profile.

4. The method for conveying human specific emergency information from a first user to a second user of claim 1, wherein user access to the user and specific human profile and data, is a paid subscription based.

5. The method for conveying human specific emergency information from a first user to a second user of claim 1, wherein the tag recognition method is a near field communication (NFC) sensor tag.

6. The method for conveying human specific emergency information from a first user to a second user of claim 1, wherein the tag embodies a barcode.

7. The method for conveying human specific emergency information from a first user to a second user of claim 1, wherein the tag embodies a snaptag image barcode.

8. The method for conveying human specific emergency information of from a first user to a second user claim 1, wherein the tag embodies an image, and wherein the tag recognition device uses image recognition technology.

9. A method for conveying human specific recreation registration and licensing information from a first user to a second user, comprising: a user specific recreation registration and licensing information profile tag, storing a computer server based user specific recreation registration and licensing information profile, and a tag recognition device; for providing a first user with a process for remotely entering, saving, and updating, user specific recreation registration and licensing information across computing devices; providing a second user with access to retrieve current recreation registration and licensing information pertaining to wildlife related registration and licensing, hunting related registration and licensing, fishing related registration and licensing and camping related registration and licensing information related to a first user, by way of data transfer from the tag to a computing device.

10. The method for conveying human specific recreation registration and licensing information from a first user to a second user of claim 9, wherein the tag embodies a quick response (QR) code.

11. The method for conveying human specific recreation registration and licensing information from a first user to a second user of claim 10, wherein the quick response (QR) code, NFC tag, Image, barcode, or snaptag is pre-generated and pre-associated with a generic “Profile Identifier” prior to any user information being entered into the profile.

12. The method for conveying human specific recreation registration and licensing information from a first user to a second user of claim 9, wherein user access to the user and specific human profile and data, is paid subscription based.

13. The method for conveying human specific recreation registration and licensing information from a first user to a second user of claim 9, wherein the tag recognition method is a near field communication (NFC) sensor tag.
